(19) United States
(12) Patent Application Publication
(10) Pub. No.: US 2012/0037385 A1
(43) Pub. Date: Feb. 16, 2012

(54) ELECTRIC POWER TOOL POWERED BY A PLURALITY OF SINGLE-CELL BATTERY PACKS

(75) Inventors: Hitoshi SUZUKI, Anjo-shi (JP); Masaaki FUKUMOTO, Anjo-shi (JP); Takuya UMEMURA, Anjo-shi (JP); Kosuke ITO, Anjo-shi (JP)

(73) Assignee: MAKITA CORPORATION, Anjo-shi (JP)

(21) Appl. No.: 13/194,119

(22) Filed: Jul. 29, 2011

(30) Foreign Application Priority Data
Aug. 11, 2010 (JP) 2010-180527

(51) Int. Cl. B25F 5/00

(52) U.S. Cl. 173/2

(57) ABSTRACT

An electric power tool comprises a tool main body, a plurality of battery packs that is detachably attached to the tool main body, and a controller that controls discharges of the battery packs attached to the tool main body. Each battery pack comprises a memory device that stores characteristic data of the rechargeable cell. The controller accesses each of the memory devices of the battery packs and controls the discharges of the battery packs based upon the characteristic data stored in the memory devices.

### CROSS REFERENCE TO RELATED APPLICATIONS

This application claims priority to Japanese patent Application No. 2010-180527 filed on Aug. 11, 2010, the contents of which are hereby incorporated by reference into the present application.

1. Technical Field

The present invention relates to an electric power tool powered by a plurality of rechargeable cells.

2. Description of the Related Art

U.S. Pat. No. 7,414,337 discloses an electric power tool. This electric power tool is provided with a tool main body and a battery pack that can be detachably attached to the tool main body. The battery pack has a housing that can be detachably attached to the tool main body and a plurality of rechargeable cells housed inside the housing and supplies electric power as a power source of the power tool to the tool main body.

### SUMMARY OF THE INVENTION

In an electric power tool powered by a battery pack, a battery pack having a nominal voltage corresponding to a rated voltage of the electric power tool is used. For example, in the electric power tool having the rated voltage of 14.4 V, a battery pack having the nominal voltage of 14.4 V is used; and in the electric power tool having the rated voltage of 18 V, a battery pack having the nominal voltage of 18 V is used. In other words, in the electric power tool having the rated voltage of 14.4 V, the battery pack having the nominal voltage of 18 V cannot be used, and in the electric power tool having the rated voltage of 18 V, the battery pack having the nominal voltage of 14.4 V cannot be used. Therefore, when the user of the electric power tool having the rated voltage of 14.4 V newly purchases an electric power tool having the rated voltage of 18 V, the user should purchase also the battery pack having the nominal voltage of 18 V. In addition to this, the battery pack having the nominal voltage of 14.4 V cannot be used for the electric power tool having the rated voltage of 18 V, even if there is no problem with the internal rechargeable cells.

In order to resolve the abovementioned problem, with the present technique, when an electric power tool is powered by a plurality of rechargeable cells, the plurality of rechargeable cells is not housed in a single battery pack, as in the conventional configuration. Instead, each rechargeable cell is configured to be individually housed in a battery pack that can be detachably attached to the tool main body. With such a configuration, each battery pack housing a single rechargeable cell can be commonly used in electric power tools having different rated voltages. For example, let us assume that a user of an electric power tool having the rated voltage of 14.4 V replaces this tool with a new electric power tool having the rated voltage of 18 V. In this case, the user can simply purchase a limited number of battery packs for the lacking 3.6 V, combine the purchased battery packs with the battery packs for 14.4 V that have been used heretofore, and use the combination of battery packs in the electric power tool having the rated voltage of 18 V.

The abovementioned single rechargeable cell may be a nickel hydride cell, a lithium ion cell, or a rechargeable cell of another type. When the battery pack houses a single lithium ion cell, the nominal voltage of the battery pack is 3.6 V. Therefore, an electric power tool having the rated voltage of 14.4 V can be driven by four battery packs, and an electric power tool having the rated voltage of 18 V can be driven by five battery packs. Thus, when the user using the electric power tool having the rated voltage of 14.4 V replaces it with the electric power tool having the rated voltage of 18 V, the user may simply purchase just one battery pack and continue using the already available four battery packs. Further, instead of the battery pack incorporating a single lithium ion cell, it is possible to buy three battery packs each incorporating a single nickel hydride cell (nominal voltage 1.2 V).

The below-described electric power tool can be realized on the basis of the above-described technique. This electric power tool includes a tool main body; a plurality of battery packs that is detachably attached to the tool main body; and a controller that controls discharges of the battery packs attached to the tool main body. Bach battery pack has a housing and a single rechargeable cell housed within the housing.

With the electric power tools of the above-described configuration becoming widespread, the users will be able to use a plurality of battery packs (rechargeable cells) for a plurality of electric power tools with different rated voltages. As a result, it will be possible to use the rechargeable cells completely to the limit of the service life thereof and the number of wastefully discarded rechargeable cells can be expected to decrease.

In order to use the battery packs more effectively, it is preferred that the above-described electric power tool is capable of using various battery packs having different characteristics in the rechargeable cells. In this case, it is preferred that the discharges of the battery packs be controlled according to characteristics of the rechargeable cells incorporated in the battery packs. For this reason, in one embodiment of the present technique, each battery pack can have a memory device that stores characteristic data indicative of the characteristics of the rechargeable cell. In this case, the controller can access the memory device of each of the battery packs attached to the tool main body and can be configured to control the discharges of the battery packs on the basis of the characteristic data stored in the memory devices.

The abovementioned memory device may store at least one characteristic value from among, for example, an upper limit in a voltage of the rechargeable cell, a lower limit in the voltage of the rechargeable cell, a maximum limit in a discharge current of the rechargeable cell, a maximum limit in the charge current of the rechargeable cell, an upper limit in a temperature of the rechargeable cell, a lower limit in the temperature of the rechargeable cell, and a capacity of the rechargeable cell as the characteristic of the rechargeable cell.

In one embodiment of the present technique, the memory device of each battery pack preferably stores at least the lower limit in the voltage of the rechargeable cell. In this case, it is preferred that the controller is capable of measuring the output voltage of each battery pack attached to the tool main body and inhibiting or restricting the discharges of the plurality of battery packs when the measured output voltage of at least one battery pack becomes lower than the lower limit in the voltage stored in the memory device of the battery pack. With such a configuration, overdischarge of the battery pack (rechargeable cell) can be prevented, and deterioration or damage of the battery pack (rechargeable cell) can be suppressed.

In one embodiment of the present technique, the controller preferably stores a maximum limit in an input voltage of the tool main body and inhibits or restricts the discharges of the plurality of battery packs when a total value of the measured output voltages of the battery packs becomes higher than the maximum limit in the input voltage of the tool main body. With such a configuration, excess voltage is prevented from being applied to the tool main body, and the motor and other electric components of the tool main body can be prevented from being damaged.

In another embodiment of the present technique, the memory device of each battery pack preferably stores at least an upper limit in a discharge voltage of the rechargeable cells. In this case, it is preferred that the controller is capable of measuring the discharge current produced by a plurality of battery packs attached to the tool main body and inhibiting or restricting the discharges of the plurality of battery packs when the measured discharge current becomes higher than the upper limit in discharge current stored in a memory device of at least one battery pack. With such a configuration, the overcurrent of the battery pack (rechargeable cell) can be prevented, and the deterioration or damage of the battery pack (rechargeable cell) can be suppressed.

In the above-described embodiment, it is preferred that the controller stores a maximum limit in input current of the tool main body and inhibit or restrict the discharges of the plurality of battery packs when the measured discharge current becomes higher than the maximum limit in input current of the tool main body. With such a configuration, the excess current is prevented from being supplied to the tool main body, and the motor and other electric components of the tool main body can be prevented from being damaged.

In another embodiment of the present technique, it is preferred that each battery pack further have a temperature measuring element that measures the temperature of rechargeable cells and the memory device of each battery pack store at least the upper limit in the temperature of the rechargeable cell. In this case, it is preferred that the controller is capable of being connected to the temperature measuring element of each battery pack attached to the tool main body and inhibiting or restricting the discharges of the plurality of battery packs when the temperature measured by the temperature measuring element of at least one battery pack becomes higher than the upper limit in the temperature stored in the memory device of the battery pack. With such a configuration, the overheating of the battery pack (rechargeable cell) can be prevented and the deterioration or damage of the battery pack (rechargeable cell) can be suppressed.

In the above-described embodiments, it is preferred that after the discharges of the plurality of batteries packs have been inhibited or restricted, the inhibition or restriction be continued till the main switch of the tool main body is turned off. With such a configuration, the inhibition or restriction of the discharges of the battery packs is prevented from being canceled by the user at an unintended timing, and the tool main body is prevented from being unexpectedly actuated.

In the electric power tool according to the present technique, a plurality of battery packs may be configured to be detachably attachable to the electric power tool by a pack holder. In this case, the pack holder may be detachably attachable to the tool main body and may be detachably attachable to the plurality of battery packs. Where the pack holder is used, it is possible to use the tool main body of the conventional electric power tool, that is, the tool main body having a single battery pack having a plurality of rechargeable cells, with the plurality of battery packs each having a single rechargeable cell.

In the electric power tool according to the present technique, at least a part of the controller can be incorporated in the tool main body. Alternatively, at least another part of the controller can be incorporated in the above-described pack holder. In one embodiment according to the present technique, one part of the controller is incorporated in the tool main body and the other part of the controller is incorporated in the pack holder. The configuration is such that the one part of the controller incorporated in the tool main body is communicatively connected to the other part of the controller incorporated in the pack holder.

### BRIEF DESCRIPTION OF THE DRAWINGS

FIG. 1 shows an electric power tool according to Embodiment 1 in which three battery packs are attached to a tool main body.

FIG. 2 shows the electric power tool according to Embodiment 1 in which the three battery packs are attached to the tool main body.

FIG. 3 is a view of the tool main body taken from the III-III direction in FIG. 2 and showing an internal structure of a battery attachment portion.

FIG. 4 is a cross-sectional view taken along the IV-IV line in FIG. 2 and showing the internal structure of the battery attachment portion.

FIG. 5 is a perspective view illustrating an external appearance of the battery pack.

FIG. 6 is a cross-sectional view taken along the VI-VI plane in FIG. 5 and showing an internal structure of the battery pack.

FIG. 7 is a circuit diagram illustrating a circuit configuration of the electric power tool according to Embodiment 1.

FIG. 8 shows an electric power tool powered by five battery packs which is a variation example of Embodiment 1.

FIG. 9 shows an electric power tool according to Embodiment 2. In this configuration, a battery holder is attached to a tool main body, and three battery packs are attached to a pack holder.

FIG. 10 shows the electric power tool according to Embodiment 2. In this configuration, the battery holder is attached to the tool main body, and the three battery packs are detached from the pack holder.

FIG. 11 is a view of the pack holder taken from the XI-XI direction in FIG. 10 and showing an internal structure of a battery attachment portion.

FIG. 12 is a cross-sectional view taken along the XII-XII line in FIG. 10 and showing the internal structure of the battery attachment portion.

FIG. 13 is a circuit diagram illustrating a circuit configuration of the electric power tool according to Embodiment 2.

FIG. 14 is a circuit diagram illustrating a variation example of the circuit configuration of the electric power tool according to Embodiment 2.

FIG. 15 is a circuit diagram illustrating another variation example of the circuit configuration of the electric power tool according to Embodiment 2.

FIG. 16 shows an electric power tool powered by five battery packs which is a variation example of Embodiment 2.

### DETAILED DESCRIPTION OF THE INVENTION

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved electric power tools, as well as methods for using and manufacturing the same.

Moreover, combinations of features and steps disclosed in the following detail description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EMBODIMENT 1

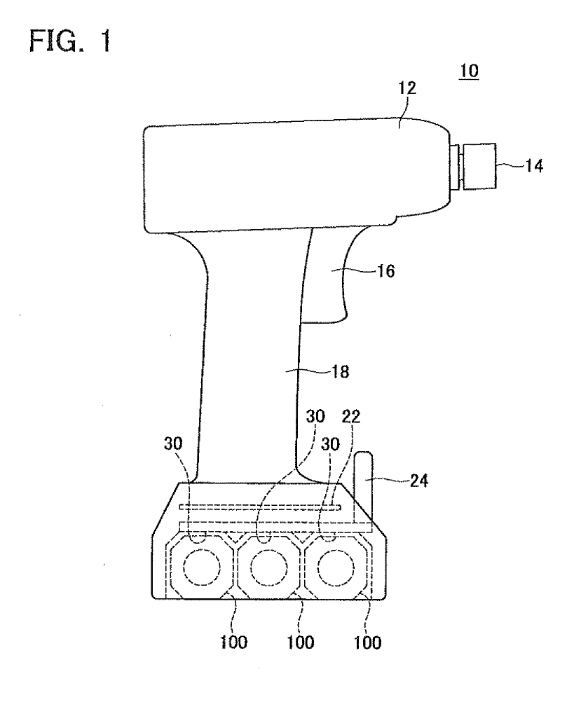

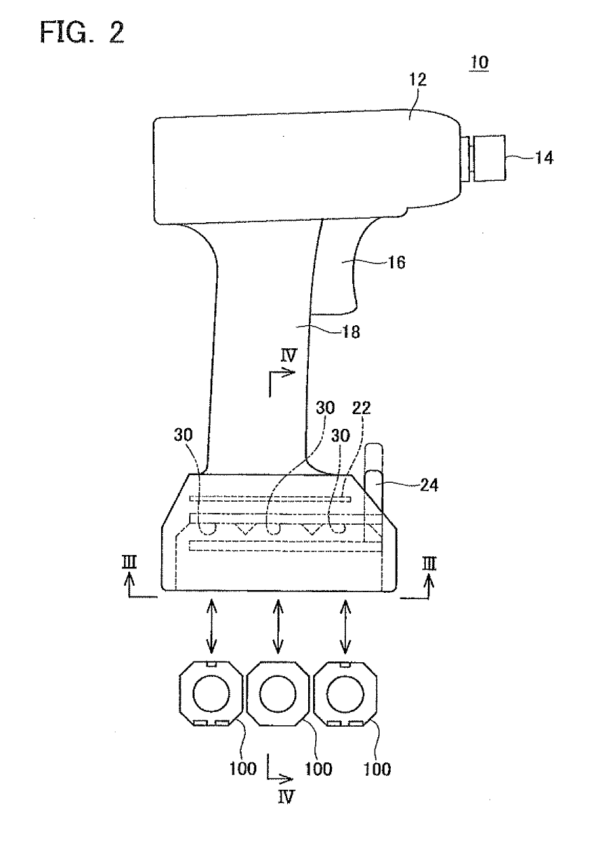

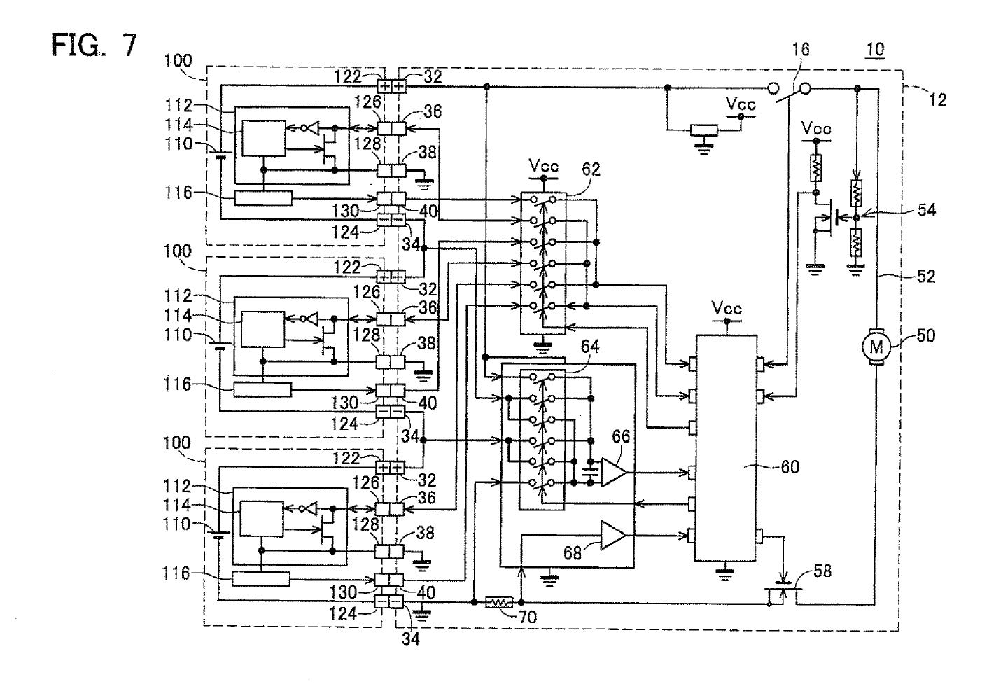

An electric power tool 10 according to Embodiment 1 will be described below with reference to the drawings. FIGS. 1 and 2 show an external appearance of the electric power tool 10. As shown in FIGS. 1 and 2, the electric power tool 10 has a tool main body 12 and a plurality of battery packs 100. The tool main body 12 is provided with a tool holder 14 for detachable attachment of the tool, a main switch 16 operated by the user, and a grip 18 held by the user. A motor 50 (see FIG. 7), which drives the tool holder 14, and a circuit board 22 are housed in the tool main body 12.

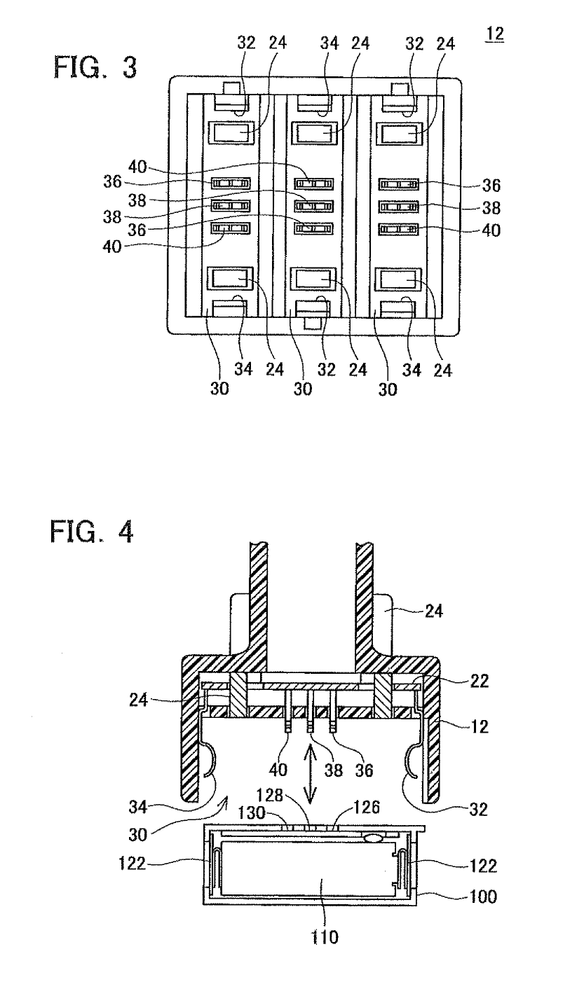

Three battery attachment sections 30 are provided in the tool main body. The three battery attachment sections 30 are positioned in the end portion of the grip 18. Each battery attachment section 30 is configured such that one battery pack 100 can be detachably attached thereto. A release member 24 for releasing the battery pack 100 from the battery attachment section 30 is provided at the tool main body 12 for each battery pack 100. As shown in FIGS. 3 and 4, each battery attachment section 30 is provided with a positive electrode input terminal 32, a negative electrode input terminal 34, a first communication terminal 36, a second communication terminal 38, and a third communication terminal 40. These terminals extend from the circuit board 22 to the battery attachment section 30.

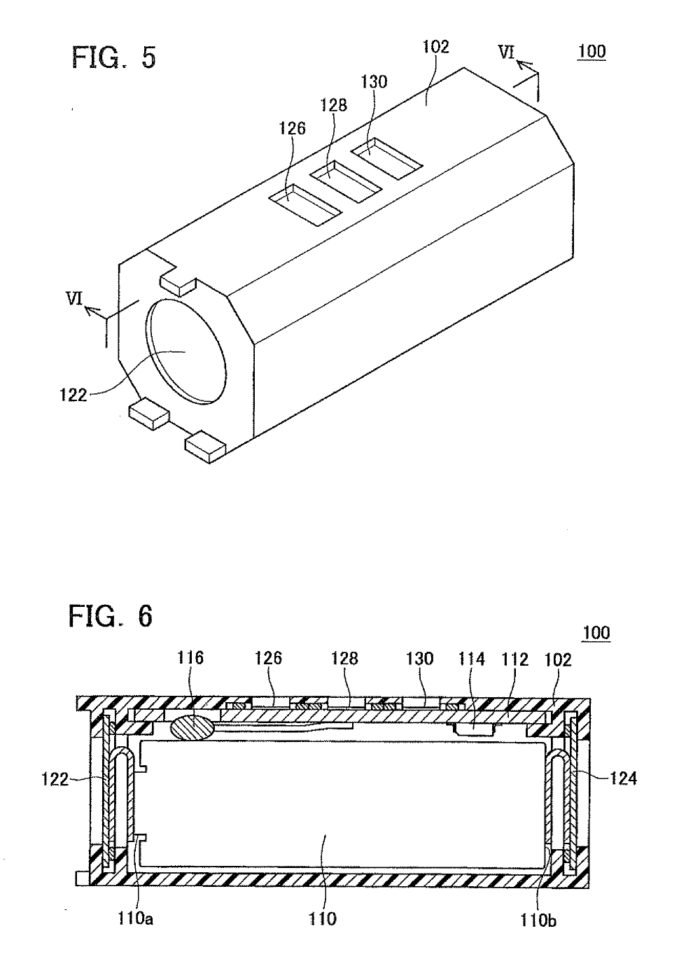

As shown in FIGS. 5 and 6, the battery pack 100 is provided with a housing 102 and a single rechargeable cell 110 housed within the housing 102. The housing 102 has a columnar shape and can be detachably attached to the battery attachment section 30 of the tool main body 12. The rechargeable cell 110 is a lithium ion cell and a nominal voltage thereof is 3.6 V. Therefore, a nominal voltage of the battery pack 100 is also 3.6 V. A rated voltage of the tool main body 12 is 10.8 V.

The battery pack 100 has a positive electrode output terminal 122 and a negative electrode output terminal 124. The positive electrode output terminal 122 is disposed at one end of the housing 102 and electrically connected to a positive terminal 110a of the rechargeable cell 110. The negative electrode output terminal 124 is disposed at the other end of the housing 102 and electrically connected to a negative electrode 110b of the rechargeable cell 110. The positive electrode output terminal 122 and the negative electrode output terminal 124 are housed within the housing 102 and exposed to the outside through an opening formed within the housing 102.

The battery pack 100 has a circuit board 112. The circuit board 112 is housed within the housing 102. A memory device (EEPROM) 114, a thermistor 116, a first communication terminal 126, a second communication terminal 128, and a third communication terminal 130 are provided at the circuit board 112. The thermistor 116 is an element for measuring a temperature of the rechargeable cell 110 and is disposed close to the rechargeable cell 110. A resistance value of the thermistor 116 changes according to the temperature of the rechargeable cell 110. The first communication terminal 126, second communication terminal 128, and third communication terminal 130 are exposed to the outside through an opening provided within the housing 102.

The memory device 114 stores characteristic data indicative of characteristics of the rechargeable cell 110. The characteristic data include characteristic values such as an upper limit in a voltage of the rechargeable cell 110, a lower limit in the voltage of the rechargeable cell 110, a maximum limit in a discharge current of the rechargeable cell 110, a minimum limit in a charge current of the rechargeable cell 110, an upper limit in the temperature of the rechargeable cell 110, a lower limit in the temperature of the rechargeable cell 110, and a capacity of the rechargeable cell 110.

FIG. 7 is a circuit diagram showing an electric configuration of the electric power tool 10. As shown in FIG. 7, in the battery pack 100, the first communication terminal 126 is connected to the memory device 114 of the circuit board 112, the second communication terminal 128 is connected to a ground terminal (not shown in the figures) of the circuit board 112, and the third communication terminal 130 is connected to the thermistor 116.

The tool main body 12 is provided with the motor 50, a power supply circuit 52, a main switch detection circuit 54, a controller 60, a first multiplexer 62, a second multiplexer 64, a buffer circuit 66, and an amplification circuit 68. The power supply circuit 52 electrically connects the positive electrode input terminal 32, negative electrode input terminal 34, and motor 50.

Where each of the three battery packs 100 are attached to the tool main body 12, the positive electrode output terminal 122 of the battery pack 100 is electrically connected to the positive electrode input terminal 32 of the tool main body 12, and the negative electrode output terminal 124 of the battery pack 100 is electrically connected to the negative electrode input terminal 34 of the tool main body 12. Inside the tool main body 12, the power supply circuit 52 connects the three battery packs 100 in series to the motor 50. Thus, the three rechargeable cells 110 are connected in series to the motor 50.

The main switch 16 is provided at the power supply circuit 52. As a result, where the user turns on the main switch 16, the power supply circuit 52 is electrically closed (connected), and where the user turns off the main switch 16, the power supply circuit 52 is electrically open (disconnected). Further, the main switch 16 is a variable-speed switch and outputs a speed command signal correspondingly to the operation amount of the turn-on operation performed by the user. The speed command signal of the main switch 16 is inputted to the controller 60.

The power supply circuit 52 is provided with a FET (field-effect transistor) 58. A gate of the FET 58 is connected to the controller 60. The controller 60 electrically opens and closes the power supply circuit 52 by turning on/off the FET 58. By controlling the FET 58, the controller 60 can inhibit and restrict the discharges of the three battery packs 100 (such control will be described below in greater detail).

The power supply circuit 52 is provided with a shunt resistor 70. The shunt resistor 70 is a resistor element for measuring the current flowing in the power supply circuit 52. The current flowing in the power supply circuit 52 is a discharge current produced by the rechargeable cell 110 and supplied to the motor 50. The voltage appearing on the shunt resistor 70 is inputted to the controller 60 via the amplification circuit 68. The controller 60 can measure the current flowing in the power supply circuit 52 on the basis of the voltage appearing on the shunt resistor 70.

The first communication terminals 126 of the three battery packs 100 are connected to respective three first communication terminals 36 of the tool main body 12. The three first communication terminals 36 of the tool main body 12 are connected to the controller 60 via the first multiplexer 62. With such a configuration, the controller 60 can access the memory devices 114 of the battery packs 100 and can acquire the characteristic data stored in the memory devices 114. The controller 60 can also write data into the memory devices 114 of the battery packs 100.

The second communication terminals 128 of the three battery packs 100 are connected to respective three second communication terminals 38 of the tool main body 12. The three second communication terminals 38 of the tool main body 12 are grounded inside the tool main body 12. With such a configuration, the circuit boards 112 of all of the battery packs 100 are grounded to the same potential as that of the controller 60 of the tool main body 12.

The third communication terminals 130 of the three battery packs 100 are connected to respective three third communication terminals 40 of the tool main body 12. The three third communication terminals 40 of the tool main body 12 are connected to the controller 60 via the first multiplexer 62. With such a configuration, the controller 60 can be connected to each of the thermistors 116 of the three battery packs 100 and can measure the temperature of the rechargeable cell 110 of each battery pack 100.

The buffer circuit 66 is connected to the positive electrode input terminal 32 and negative electrode input terminal 34 of each battery attachment portion 30. The buffer circuit 66 is selectively connected to the electrode input terminal 32 and negative electrode input terminal 34 of one battery attachment portion 30 and outputs a signal corresponding to a voltage between the electrode input terminal 32 and the negative electrode input terminal 34. The output signal of the buffer circuit 66 is inputted to the controller 60. The controller 60 can measure the output voltage of each battery pack 100 (that is, rechargeable cell 110) by controlling the second multiplexer 64 and receiving the output signal of the buffer circuit 66.

The main switch detection circuit 54 detects the ON/OFF state of the main switch 16. With the circuit configuration shown in FIG. 7, the main switch detection circuit 54 outputs a high-level voltage signal (Vcc) to the controller 60 as long as the main switch 16 is turned off, and outputs a low-level voltage signal (GND) to the controller 60 as long as the main switch 16 is turned on. The controller 60 can detect the ON/OFF state of the main switch 16 on the basis of the output signal of the main switch detection circuit 54.

In the electric power tool 10 according to the present embodiment, the controller 60 controls the discharges of three battery packs 100 attached to the tool main body 12. The controller 60 can access the memory device 114 of each battery pack 100 attached to the tool main body 12 and can control the discharges of the three battery packs 100 on the basis of the characteristic data stored in the memory device 114. A prime example of discharge control executed by the controller 60 will be explained below.

The controller 60 can measure the output voltage of each battery pack 100 by using the buffer circuit 66 and inhibits the discharges of the battery packs 100 by turning off the FET 58 when the measured value of the output voltage of at least one battery pack 100 becomes lower than the lower limit in the voltage stored in the memory device 114 of this battery pack 100. As a result, the overdischarge of the battery pack 100 (rechargeable cell 110) is prevented, and the deterioration or damage of the battery pack 100 (rechargeable cell 110) is suppressed. The controller 60 may partially restrict the discharges of the battery packs 100 by intermittently turning off the FET 58, without completely inhibiting the discharges of the battery packs 100.

In addition, the controller 60 stores the maximum limit in input voltage of the tool main body 12 and can partially restrict the discharges of the battery packs 100 by intermittently turning off the FET 58 when a total value of the measured output voltages of the battery packs 100 becomes higher than the maximum limit in the input voltage of the tool main body 12. Thus, by performing PWM control of the FET 58, the controller 60 can reduce the voltages supplied from the three battery packs 100 to the tool main body 12 to a value equal to or lower than the maximum limit input voltage of the tool main body 12. As a result, the excessive voltage can be prevented from being supplied to the tool main body 12, and the motor 50, main switch 16, and the like can be prevented from being damaged. The controller 60 may also completely turn off the FET 58 and inhibit the discharges of the battery packs 100.

The controller 60 measures the discharge current created by the three battery packs 100 by using the shunt resistor 70 and can inhibit (interrupt) the discharges of the battery packs 100 by turning off the FET 58 when the measured discharge current becomes larger than the upper limit in the discharge current stored in the memory device 114 of at least one battery pack 100. With such a configuration, the overcurrent of the battery packs 100 (rechargeable cells 110) is prevented, and the deterioration or damage of the battery packs 100 (rechargeable cells 110) is suppressed. The controller 60 may partially restrict the discharges of the battery packs 100 by intermittently turning off the FET 58, without completely inhibiting the discharges of the battery packs 100.

In addition, the controller 60 stores data indicative of a maximum limit in input current of the tool main body 12 and can inhibit (interrupt) the discharges of the battery packs 100 by turning off the FET 58 when the measured discharge current becomes larger than the maximum limit in input current of the tool main body 12. As a result, an excessively high current can be prevented from being supplied to the power supply circuit 52 of the tool main body 12, and the motor 50, main switch 16, and the like can be prevented from damage. Further, the controller 60 may partially restrict the discharges of the battery packs 100 by intermittently turning off the FET 58, without completely inhibiting the discharges of the battery packs 100.

The controller 60 is connected to the thermistor 116 of each of the battery packs 100 and can inhibit the discharges of the battery packs by turning off the FET 58 when the value measured by the thermistor 116 of at least one battery pack 100 becomes higher than the upper limit in temperature stored in the memory device 114 of the battery pack. As a result, overheating of the battery packs 100 (rechargeable cells 110) can be prevented and deterioration or damage of the battery packs 100 (rechargeable cells 110) is suppressed. The controller 60 may partially restrict the discharges of the battery packs 100 by intermittently turning off the FET 58, without completely inhibiting the discharges of the battery packs 100.

As described hereinabove, the controller 60 can inhibit or restrict the discharges of the battery packs 100 according to the voltage, current, and temperature of the battery packs 100 (rechargeable cells 110). Here, the controller 60 is configured such that once the discharges of the battery packs 100 have been inhibited or restricted, the inhibition or restriction of the discharges is continued till the main switch 16 is detected by the main switch detection circuit 54 to be turned off. As a result, the inhibition or restriction of the discharges of the battery packs 100 is prevented from being canceled by the user at an unintended timing, and the tool main body 12 is prevented from being unexpectedly actuated.

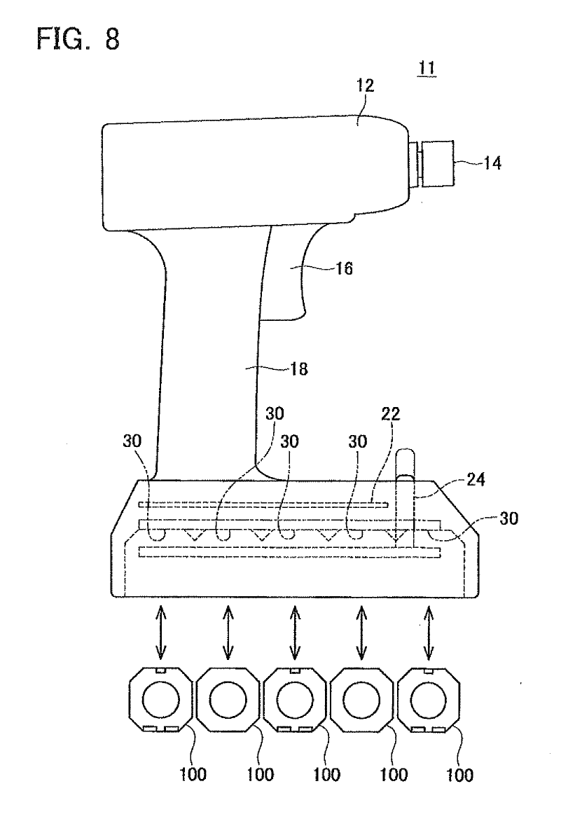

In the above-described electric power tool 10, the rated voltage of the tool main body 12 is 10.8 V and the nominal voltage of the battery pack 100 is 3.6 V. Therefore, three battery packs 100 are used. It goes without saying that the rated voltage of the tool main body 12 is not limited to 10.8 V and the number of battery packs 100 used is also not limited to three. For example, the rated voltage of the tool main body 12 may be 18 V and the number of battery packs 100 used may be five or more, as in an electric power tool 11 shown in FIG. 8.

The battery packs 100 can be commonly used by the user in the electric power tool 10 having the rated voltage of 10.8 V and the electric power tool 11 having the rated voltage of 18 V. Therefore, the user can effectively use the available battery packs 100. For example, the user using the electric power tool 10 having the rated voltage of 10.8 V replaces it with the electric power tool 11 having the rated voltage of 18 V. In this case, the user can simply purchase just two more battery packs 100 that are lacking, combine them with the three battery packs 100 that have been heretofore used, and use the battery packs altogether in the electric power tool 11 having the rated voltage of 18 V. Further, the battery packs 100 can be replaced in the order from that in which the internal rechargeable cells 110 have completely deteriorated.

### EMBODIMENT 2

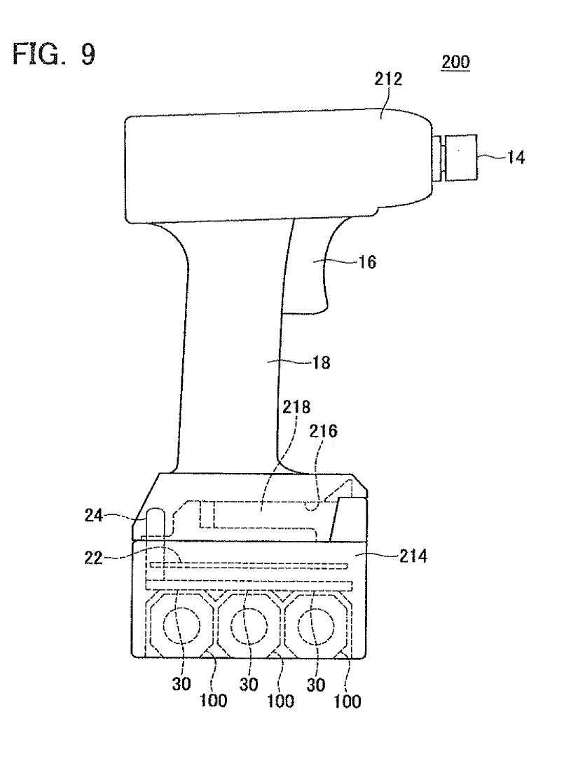

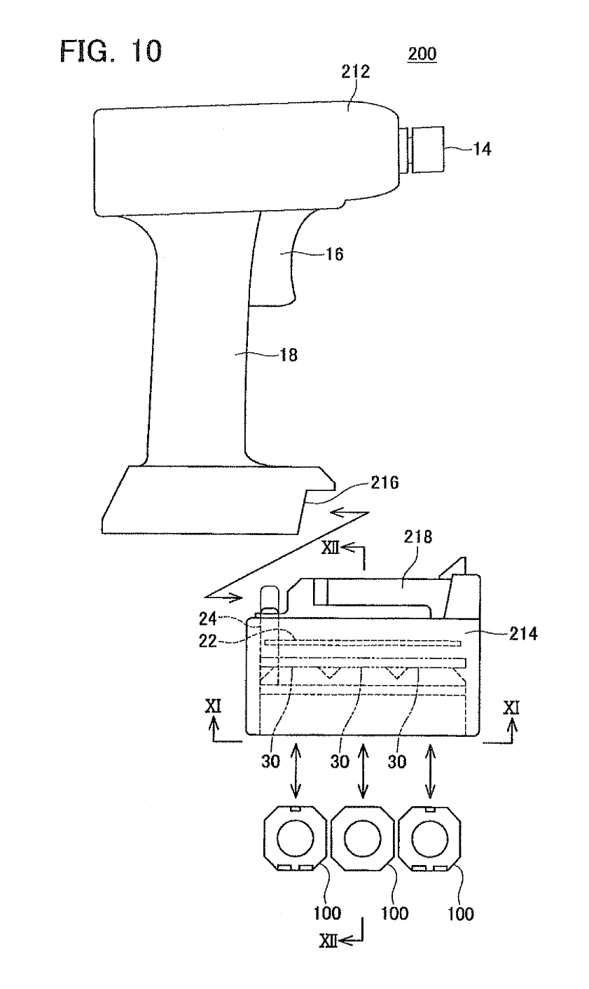

An electric power tool 200 according to Embodiment 2 will be explained below with reference to the drawings. FIGS. 9 and 10 illustrate the external appearance of the electric power tool 200 according to Embodiment 2. As shown in FIGS. 9 and 10, the electric power tool 10 has a tool main body 212, a plurality of battery packs 100, and a pack holder 214. By contrast with the electric power tool 10 according to Embodiment 1, the electric power tool 200 according to Embodiment 2 is configured such that the three battery packs 100 are detachably attached to the tool main body 212 by the pack holder 214. The electric power tool 200 according to Embodiment 2 is described below in greater detail, but components common with the electric power tool 10 according to Embodiment 1 are assigned with same reference numerals and the explanation thereof is omitted.

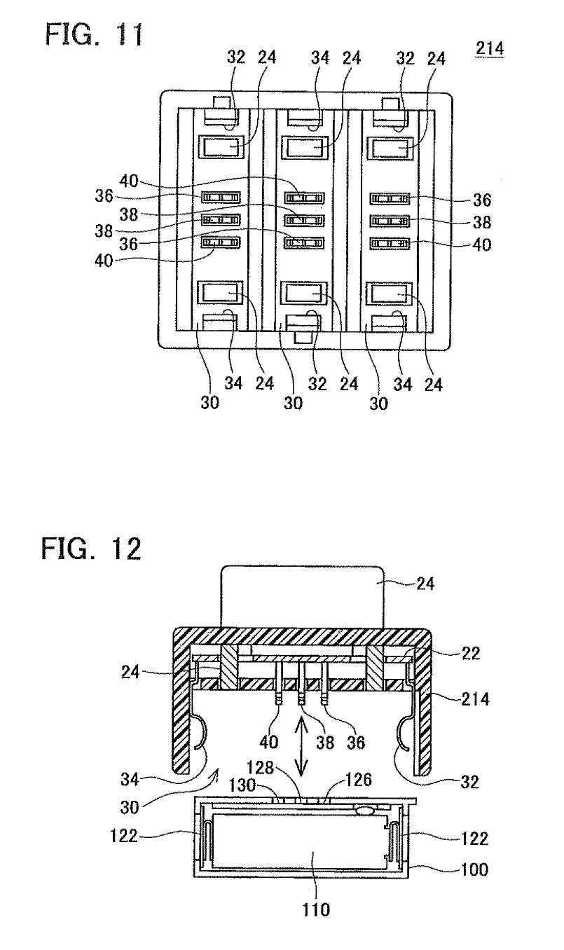

One battery attachment portion 216 is provided in the tool main body 212. A tool connector 218 is provided on the upper surface of the pack holder 214. The tool connector 218 of the pack holder 214 can be detachably attached to the battery attachment portion 216 of the tool main body 212. Three battery attachment portions 30 are provided on the lower surface of the pack holder 214. As shown in FIGS. 11 and 12, the battery attachment portion 30 of the pack holder 214 has a configuration identical to that of the battery attachment portion 30 of the electric power tool 12 explained in Embodiment 1. One battery pack 100 can be detachably attached to each battery attachment portion 30. The conventional battery pack in which a plurality of rechargeable cells is housed in a single housing can be attached, instead of the pack holder 214, to the battery attachment portion 216 of the tool main body 212.

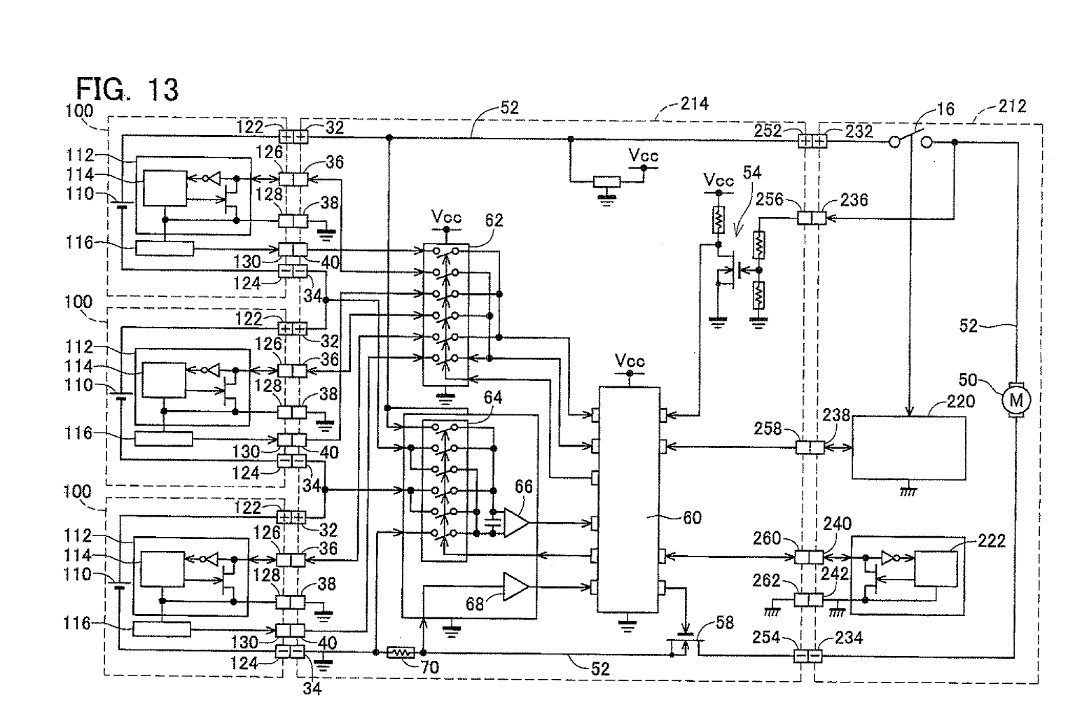

FIG. 13 is a circuit diagram showing the electric configuration of the electric power tool 200. The tool main body 212 is provided with a motor 50, part of a power supply circuit 52, a tool controller 220, and a memory device 222. The tool controller 220 is connected to a main switch 16, and a speed command signal outputted by the main switch 16 is inputted to the tool controller 220. Characteristic data of the tool main body 212 is stored in a memory device 222. The characteristic data includes a maximum limit in input voltage of the tool main body 212 and a maximum limit in input current of the tool main body 212.

In addition, the tool main body 212 is provided with a positive electrode input terminal 232, a negative electrode input terminal 234, a first communication terminal 236, a second communication terminal 238, a third communication terminal 240, and a fourth communication terminal 242. These terminals are disposed at the battery attachment portion 216 of the tool main body 212. The positive electrode input terminal 232 and the negative electrode input terminal 234 are electrically connected to the motor 50. The first communication terminal 236 is connected to the motor 50 side of the main switch 16. The second communication terminal 238 is electrically connected to the tool controller 220. The third and fourth communication terminals 240, 2421 are electrically connected to the memory device 222.

The pack holder 24 is provided with part of the power supply circuit 52, a main switch detection circuit, a controller 60, a first multiplexer 62, a second multiplexer 64, a buffer circuit 66, and an amplification circuit 68. The power supply circuit 52 is provided with a FET 58 and a shunt resistor 70.

In addition, the pack holder is provided with a positive electrode output terminal 252, a negative electrode output terminal 254, a first communication terminal 256, a second communication terminal 258, a third communication terminal 260, and a fourth communication terminal 262. These terminals are disposed at the tool connector 218 of the pack holder 214. The positive electrode output terminal 252 is electrically connected to the positive electrode input terminal 32 via the power supply circuit 52. The negative electrode output terminal 254 is electrically connected to the negative electrode input terminal 34 via the power supply circuit 52. The first communication terminal 256 is electrically connected to the main switch detection circuit 54. The second communication terminal 258 and the third communication terminal 260 are electrically connected to the controller 60. The fourth communication terminal 262 is electrically connected to a ground potential of the circuit of the back holder 214.

As shown in FIG. 13, where the pack holder 214 is attached to the tool main body 212, the terminals 252, 254, 256, 258, 260, 262 of the pack holder 214 are electrically connected to the corresponding terminals 232, 234, 236, 238, 240, 242 of the tool main body 212. As a result, the controller 60 of the back holder 214 is communicatively connected to the tool controller 220 and memory device 222 of the tool main body 212. The controller 60 of the pack holder 214, and the tool controller 220 and the memory device 222 of the tool main body 212 cooperatively function similarly to the controller 60 explained in Embodiment 1.

It should be noted that, in the electric power tool 200 of the present embodiment, the controller 60 of the pack holder 214 accesses the memory device 222 of the tool main body 212 and acquires characteristic data (maximum limit in input voltage and maximum limit in input current) of the tool main body 212. The FET 58 is then turned on/off and the discharges of the battery packs 100 are controlled on the basis of the acquired characteristic data of the tool main body 212. Therefore, the pack holder 214 and the plurality of battery packs 100 are not limited to a specific tool main body 212 and can be commonly used in a plurality of tool main bodies 212.

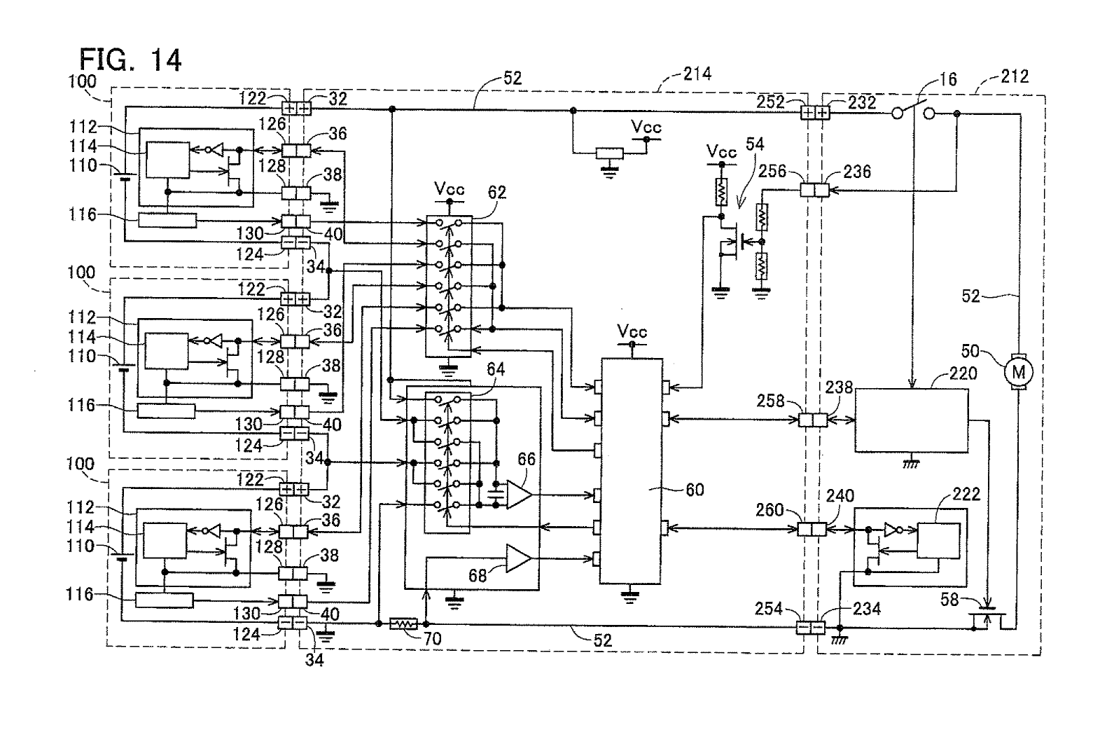

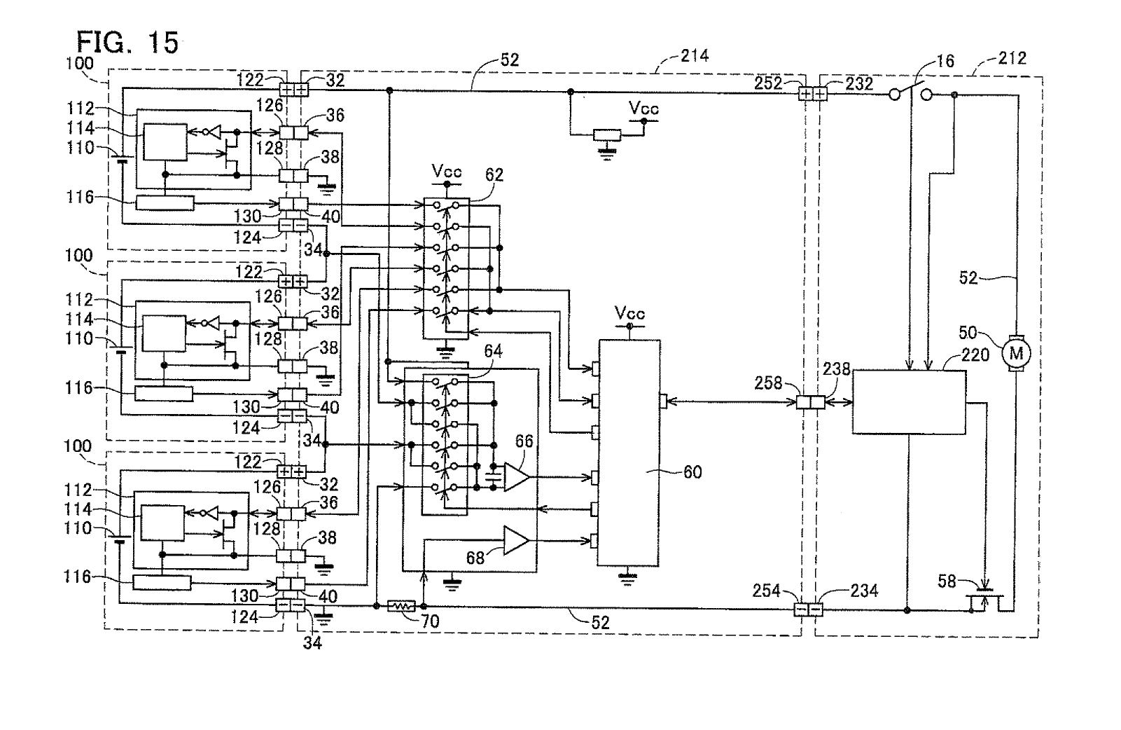

In the electric power tool 200 according to Embodiment 2, the circuit configuration shown in FIG. 13 can be changed as appropriate. For example, as shown in FIG. 14, the FET 58 may be disposed on the tool main body 212 and the control of the FET 58 may be performed by the tool controller 220. Alternatively, the circuit configuration may be changed to that shown in FIG. 15. In such circuit configuration, the controller 60 of the pack holder 214 measures indexes such as the output voltage and discharge current of the battery pack 100 and outputs a command signal for inhibiting or restricting the discharges of the battery packs 100. This signal is transmitted to the tool controller 220 of the tool main body 212 via the communication terminals 258, 238. The tool controller 220 receives the signal from the controller 60 of the pack holder 214 and performs the processing of inhibiting or restricting the discharges of the battery packs 100, that is, turns off the FET 58. With such a configuration, the number of communication terminals between the tool main body 212 and the pack holder 214 can be reduced.

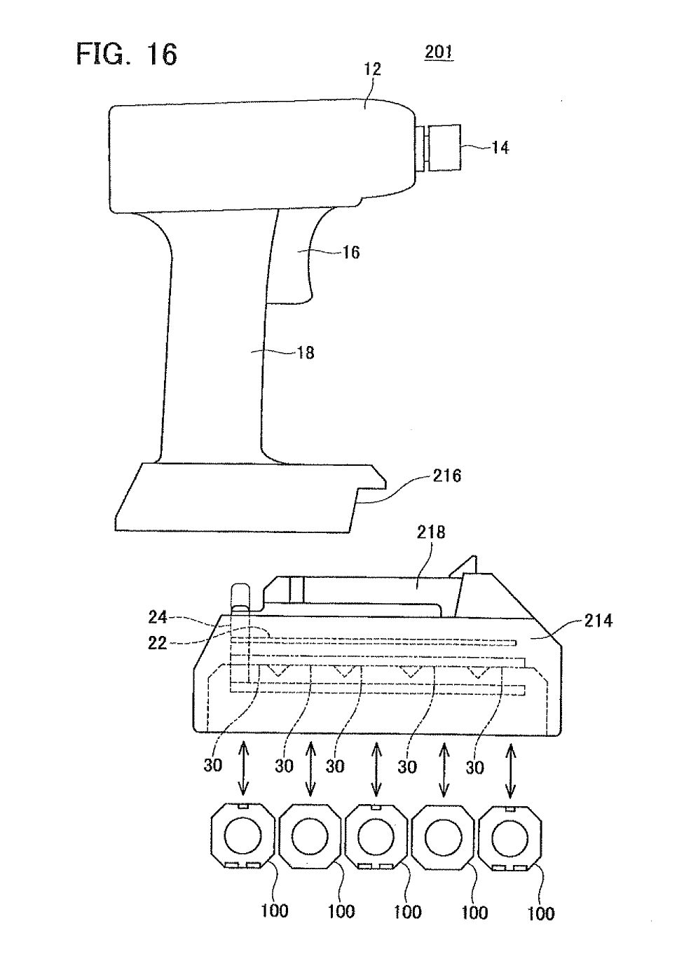

In the above-described electric power tool 10, the rated voltage of the tool main body 212 is 10.8 V and the nominal voltage of the battery pack 100 is 3.6 V. Therefore, three battery packs 100 are used. It goes without saying that the rated voltage of the tool main body 212 is not limited to 10.8 V and the number of battery packs 100 used is also not limited to three. For example, the rated voltage of the tool main body 212 can be 18 V and the number of battery packs 100 used can be five or more, as in an electric power tool 201 shown in FIG. 16.

What is claimed is:

1. An electric power tool comprising:
a tool main body;
a plurality of battery packs that is detachably attached to the tool main body; and
a controller that controls discharges of the battery packs attached to the tool main body,
wherein each battery pack comprises a housing and a single rechargeable cell housed within the housing.

2. The electric power tool as in claim 1, wherein
each battery pack further comprises a memory device that stores characteristic data of the rechargeable cell, and
the controller accesses each of the memory devices of the battery packs and controls the discharges of the battery packs based upon the characteristic data stored in the memory devices.

3. The electric power tool as in claim 2, wherein
the memory device of each battery pack stores at least data indicative of a lower limit in a voltage of the rechargeable cell, and
the controller measures an output voltage of each battery pack, and inhibits or restricts the discharges of the battery packs when the measured output voltage of at least one battery pack becomes lower than the lower limit in the voltage stored in the memory device of the at least one battery pack.

4. The electric power tool as in claim 3, wherein
the controller stores data indicative of an upper limit in an input voltage of the tool main body, and inhibits or restricts the discharges of the battery packs when a total value of the measured output voltages of the battery packs becomes higher than the maximum limit in the input voltage of the tool main body.

5. The electric power tool as in claim 2, wherein
the memory device of each battery pack stores at least data indicative of an upper limit in a discharge current of the rechargeable cell, and
the controller measures the discharge current from the battery packs attached to the tool main body, and inhibits or restricts the discharges of the battery packs when the measured discharge current becomes larger than at least one of the upper limits stored in the memory devices of the battery packs.

6. The electric power tool as in claim 5, wherein
the controller stores data indicative of an upper limit in an input current of the tool main body, and inhibits or restricts the discharges of the battery packs when the measured discharge current becomes larger than the upper limit in the input current of the tool main body.

7. The electric power tool as in claim 2, wherein
each battery pack further comprises a temperature sensor that measures a temperature of the rechargeable battery pack,
the memory device of each battery pack stores at least data indicative of an upper limit in the temperature of the rechargeable cell, and
the controller accesses each temperature sensor of the battery packs attached to the tool main body, and inhibits or restricts the discharges of the battery packs when the temperature measured by the temperature sensor of at least one battery pack becomes higher than the upper limit in the temperature stored in the memory device of the at least one battery pack.

8. The electric power tool as in claim 2, wherein
once the controller inhibits or restricts the discharges of the battery packs, the controller continues to inhibit or restrict the discharges of the battery packs until a main switch of the tool main body is turned off.

9. The electric power tool as in claim 1, further comprising a pack holder that is detachably attached to the tool main body,
wherein the plurality of battery packs is configured to be detachably attached to the pack holder and is detachably attached to the tool main body via the pack holder.

10. The electric power tool as in claim 9, wherein at least a part of the controller is housed within the tool main body.

11. The electric power tool as in claim 9, wherein at least a part of the controller is housed within the pack holder.

12. The electric power tool as in claim 9, wherein
a part of the controller is housed within the tool main body,
another part of the controller is housed within the pack holder, and
the part of the controller housed within the tool main body is connected to the part of the controller housed within the pack holder, and are capable of communicating with each other.
